(19) United States
(12) Patent Application Publication
(10) Pub. No.: US 2016/0340515 A1
(43) Pub. Date: Nov. 24, 2016

(54) PHOSPHOR-FREE, ECO-FRIENDLY ZIRCONIUM COATING AGENT ALLOWING FOR USE OF INDUSTRIAL WATER AND METHOD OF USING THE SAME

(71) Applicants: Dong Ju JUNG, Daegu (KR); Sung Gu JUNG, Daegu (KR)

(72) Inventors: Dong Ju JUNG, Daegu (KR); Sung Gu JUNG, Daegu (KR)

(21) Appl. No.: 14/720,289

(22) Filed: May 22, 2015

(51) Int. Cl. C09D 5/08; B05D 5/00; B05D 3/00; B05D 7/14

(52) U.S. Cl. CPC C09D 5/084; B05D 7/14; B05D 5/00; B05D 3/002

(57) ABSTRACT

The present invention relates to an implementation of a zirconium coating agent allowing industrial water or tab water to be used in a zirconium coating process or in a rinsing process right prior to the zirconium coating process. The zirconium coating agent contains an organic functional group (O.F.G) that aids in coating by preventing calcium ions (Ca²⁺) in the industrial water from bonding with fluorine ions (F⁻) in a conventional zirconium coating agent while leaving them free ions. The zirconium coating agent also contains calcium ions (Ca²⁺) that may provide anti-rust properties. The zirconium coating agent is phosphor-free. Accordingly, according to the present invention, use of the zirconium coating agent may meet the painting quality required in automobile industry and allows for accelerated zirconium coating (15 seconds to two minutes) together with simultaneous chemical conversion for various metals (steel, zinc, and aluminum).

### TECHNICAL FIELD

The present invention concerns a coating agent for metal painting, and more specifically, to a phosphor-free, eco-friendly zirconium coating agent that is treated before metal painting to allow for use of industrial water.

### DISCUSSION OF RELATED ART

Surface coating with an anti-rust oil may allow the metal surface an increased anti-rust property but still fails to produce a high-quality painting result due to various contaminants left on the metal surface, such as rust, dust, or oil sludge.

For better anti-rust or other painting properties, the metal surface may be coated with a metal phosphate before painting.

Chemicals for phosphate coating, since their first version was produced in 1915 by C.W. Parker (U.S.), have continued to develop and build on achievements such as increased coating quality and savings in energy, resources, and labor. In particular, application of developed phosphate coating agents to automobile industry led to prominent enhancements in automobile painting quality. A car would not experience scratches or peeling-off on its painted surface with a minor collision. The paint coatings on the surface of a car may firmly stick to the metal surface thereunder, leaving the car rust-free and in its esthetic appearance ten years or more in whatever outdoor weather conditions the car is supposed to be.

There are a few patent documents that deal with use of conventional types of phosphate coating compositions.

As conventional arts regarding coating agents (also referred to as chemical conversion agents) used in a phosphate coating process, Japanese Patent Application Publication No. 563-223186 (published on Sep. 16, 1988) discloses a phosphate coating agent containing, at 25° C. to 45° C., zinc (Zn) ions of 1500 to 3000 mg/l, manganese (Mn) ions of 500 to 5000 mg/l, nickel (Ni) ions of 500 to 5000 mg/l, phosphate (PO₄) ions of 5000 to 30000 mg/l, and nitrate (NO₃) ions of 500-2000 mg/l. Japanese Patent No. H3-20476 (published on Jan. 29, 1991) discloses a phosphate coating agent containing zinc (Zn) ions of 2000 to 20000 mg/l, phosphate (PO₄) ions of 5000 to 40000 mg/l, nickel (Ni) ions of 420 mg/l, and nitrate (NO₃) ions of 7500 to 13500 mg/l.

However, as a recent worldwide trend pursues “eco-friendly” materials, lead (Pb), an environmental contaminant, was banned from use in electrodeposit compositions, and so was chrome (Cr⁺⁶) that had been widely used in aluminum metal surface treating agents.

Metal phosphate coating agents that have had broad applications cannot be exempt from such efforts to reduce environmentally harm materials because they contain a vast amount of environmental contaminants such as phosphoric acid (H₃PO₄), zinc (Zn), manganese (Mn), nickel (Ni), and nitric acid (HNO₃).

Vigorous efforts to research and develop eco-friendly surface treatment agents are ongoing in Japan. As per the August 2014 issue of a Japanese painting technique magazine, a Japanese company, sponsored by the Japanese government and a Japanese municipal research organization, announced that they have developed a phosphor-free coating agent using zirconium in place of phosphate and zinc.

However, the zirconium coating agent showed a satisfactory result for only 120 hours when applied to a cold-rolled steel plate in the salt water spraying test after painting, which is far away from 800 hours or more that is required to be met in automobile industry.

### PRIOR ART DOCUMENTS

### Patent Documents

Korean Patent No. 10-1359967, titled “phosphoric acid-based surface treatment composition”

Korean Patent No. 10-0317680, titled “surface treatment agent for coating ground that may simultaneously treat aluminum alloy and steel plate”

Japanese Patent Application Publication No. S63-223186 (published on Sep. 16, 1988)

Japanese Patent Application Publication No. S3-20476 (published on Jan. 29, 1991)

### SUMMARY

Accordingly, the present invention aims to provide an eco-friendly zirconium coating agent that meets quality requirements of automobile industry and a method of using the same.

Another object of the present invention is to provide an eco-friendly zirconium coating agent that may reduce environmental contamination to 1/100 or more of that of phosphate coating agents and has good anti-rust properties (meet 1000 hours or more in the salt water spraying test) and shortened processing time (15 seconds to two minutes) and a method using the same.

Still another object of the present invention is to provide a phosphor-free zirconium coating agent that may simultaneously apply to various metals such as steel, zinc, or aluminum, has anti-rust properties, and allows for use of industrial water and a method of using the same.

According to an aspect of the present invention, there is provided a phosphor-free, eco-friendly zirconium coating agent composed by adding, to a conventional zirconium coating agent essentially containing fluorine ions (F⁻), a material having a bonding force larger than calcium fluoride (CaF) and preventing a material dissolved in water from bonding with calcium fluoride (CaF) to thus allow industrial water or tab water with a calcium ion (Ca²⁺) content up to 75 mg/l and an electric conductivity of 100 to 300 μs/cm to be used in a zirconium coating process or a rinsing process prior to the zirconium coating process.

The material is an organic functional group (O.F.G):

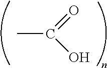

Preferably, the O.F.G is an anion carboxyl group.

The phosphor-free, eco-friendly zirconium coating agent further comprises calcium ions (Ca²⁺) to allow an anti-rust property and an anti-corrosive and painting adhesive property after painting.

The content X of the O.F.G is obtained using the following equation:

$$X ( mg \text{/} l ) = A - ( B + C ) \times f \times \frac{1000}{5} \times 0.2$$

where, f: factor of 0.1N—KMnO4

5: volume (ml) of specimen

C: ion amount of iron (Fe)

According to another aspect of the present invention, there is provided a phosphor-free, eco-friendly zirconium coating agent allowing for use of industrial water, the zirconium coating agent composed to contain, at least, calcium ions (Ca²⁺) of 20 to 150 mg/l, zirconium ions of 30 to 500 mg/l, and an organic functional group (O.F.G) of 25 to 300 mg/l to allow for use in a zirconium coating process or a rinsing process prior to the zirconium coating process and to provide an anti-rust property and an anti-corrosive property and adhesivity after painting.

According to another aspect of the present invention, there is provided a phosphor-free, eco-friendly zirconium coating agent allowing for use of industrial water, -), the zirconium coating agent containing an organic functional group (O.F.G) having a bonding force larger than calcium fluoride (CaF) and preventing a material dissolved in water from bonding with calcium fluoride (CaF) to thus allow industrial water or tab water to be used in a zirconium coating process or a rinsing process prior to the zirconium coating process, wherein the O.F.G has the following structural formula:

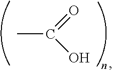

and wherein a zirconium coating layer is formed by a coating action following the following chemical reaction equation using the zirconium coating agent:

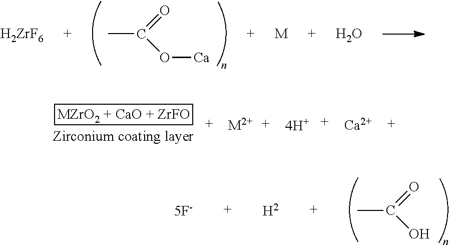

According to another aspect of the present invention, there is provided a phosphor-free, eco-friendly zirconium coating agent allowing for use of industrial water, the zirconium coating agent containing a functional group by which a zirconium coating layer is formed by performing a coating process on a steel, zinc (Zn), or aluminum (Al) material with the zirconium coating agent, wherein the O.F.G is configured to be represented in the following chemical formula:

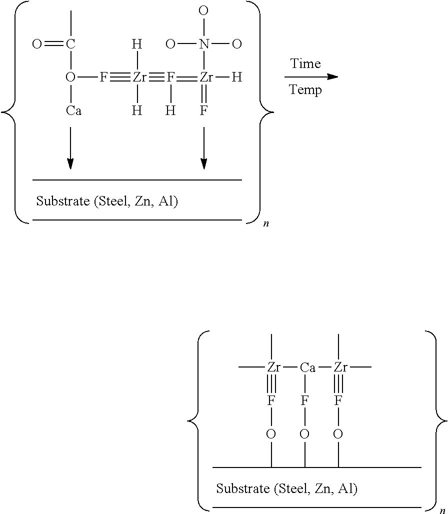

According to an aspect of the present invention, there is provided a method of using a phosphor-free, eco-friendly zirconium coating agent allowing for use of industrial water, the zirconium coating agent being a liquid agent containing calcium ions of 20 to 150 mg/l, zirconium ions of 30 to 500 mg/l, and an organic functional group (O.F.G) of 25 to 300 mg/l and used in a zirconium coating process, wherein industrial water or tab water (electric conductivity of 100 to 300 μs/cm), not deionized water or R.O water with an electric conductivity of 50 μs/cm or less is adopted in a make-up process of the zirconium coating process or a rinsing process prior to the zirconium coating process.

Coating in the zirconium coating process is performed for 15 seconds to 120 seconds at 20 to 35° C.

According to the present invention, a phosphor-free, eco-friendly zirconium coating agent is implemented that contains calcium ions for anti-rust, allows for use of industrial water, and meets the painting quality requirements in the automobile industry. The zirconium coating agent may reduce environmental pollution to 1/100 of that of conventional phosphate coating agents. Further, according to the present invention, the zirconium coating agent exhibits excellent anti-rust properties (meets 1000 hours or more in the salt water spraying test) and shortened processing time (15 seconds to two minutes) while enabling a simultaneous coating (chemical conversion) process of various metals (steel, zinc, or aluminum).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1a and 1b are photographs showing results obtained by conducting natural drying 20 minutes after phosphate coating and zirconium coating that leave the water used for rinsing;

FIG. 2 is a photograph illustrating a coating layer formed by conducting natural drying 20 minutes after conducting coating with a zirconium coating agent containing calcium ions (Ca²⁺) according to an embodiment of the present invention;

FIGS. 3a to 3c are concept views illustrating formation of a zirconium coating on steel, zinc, and aluminum materials according to embodiments of the present invention; and

FIGS. 4a to 4c are views illustrating measurement results of investigating the components of the zirconium coating layer formed on the surface of the steel, zinc (Zn), and aluminum (Al) material shown in FIGS. 3a to 3c using EDS (energy dispersive x-ray spectroscopy), according to the present invention.

### DETAILED DESCRIPTION OF EMBODIMENTS

Embodiments of the present invention are described in detail with reference to the accompanying drawings.

As described above in the DISCUSSION OF RELATED ART section, a zirconium chemical conversion agent, as an eco-friendly metal surface treating chemical conversion agent (coating agent), has been used as a replacement of a conventional phosphate chemical conversion agent, with the benefit of being capable of simultaneously treating iron, zinc and its alloy and an aluminum-based metal and being used at a low temperature (from a room temperature to 35° C.).

The mechanism is as follows:

H₂ZrF₆+M+2H₂O→MZrO₂(coating)+4H⁺+6F⁻+H₂

where, M is iron, zinc (Zn), or aluminum (Al)-based material.

The following Table 1 shows pre-, or post-processes related to the known zirconium coating.

TABLE 1

| Process name | | | | | | | | |
|---|---|---|---|---|---|---|---|---|
| | | | 4. | | | | | |
| | | | chemical | | | 7. | | 9. |
| 1. | 2. | 3. | conversion | 5. | 6. | rinsing with | 8. | electro |
| degreasing | rinsing | rinsing | (coating) | rinsing | rinsing | pure water | draying | deposition |

| | | | | | | | |
|---|---|---|---|---|---|---|---|
| Temperature | 45° C. | Room | Room | 15~35° C. | Room | Room | Room |
| | | temperature | temperature | | temperature | temperature | temperature |
| Time | 2 min. | 1 min. | 1 min. | 2 min. | 1 min. | 1 min. | 1 min. |
| Water used | Industrial | Industrial | Deionized | Deionized | Industrial | Deionized | Deionized |
| | water | water | water or | water or | water | water or | water or |
| | | | R.O water | R.O water | | R.O water | R.O water |

Here, the processes 2 and 5, rinsing, may be performed with industrial water or tab water (electric conductivity: 100 to 300 μs/cm), but the processes 3 and 5, rinsing, using a conventional zirconium coating agent should be performed with deionized water or reverse osmosis (R.O) water (electric conductivity: 50 μs/cm or less).

Use of industrial water, instead of deionized water, in rinsing might cause calcium ions (Ca²⁺) or other dissolved ions (e.g., Mg or Fe ions) in the industrial water to deteriorate the zirconium coating or to leave a calcium fluoride (CaF) deposit on the zirconium coating, obstructing the coating or deposition.

The zirconium coating agent or zirconium chemical conversion agent (hereinafter, simply referred to as ‘zirconium coating agent’) is eco-friendly and thus makes sure to replace conventional phosphate chemical conversion agents. However, it tends be reluctant to adopt in the industry like automobile manufacturing.

The following reasons may be persuasive.

First, deionized water (D.I water) or R.O water (electric conductivity of 50 μs/cm or less) should be put to use in rinsing performed ahead of zirconium coating and drying for zirconium coating. Accordingly, an additional facility for producing deionized water or R.O water is required to apply to the processes, thus leading to increased operation costs.

Upon use of deionized water, an ion exchange resin is adopted to remove cations (e.g., Ca²⁺, Fe⁺, or Mn⁺) or anions (e.g., Cl⁻ or SO₄⁻), requiring a high-capacity device. After about a week of use, the ion exchange resin experiences degradation in exchange performance, and thus, it needs to be recycled with hydrochloric acid (HCl) and caustic soda (NaOH). This causes overburden. Further, a change in pH or other secondary environmental contamination may arise.

The same burden or difficulty is caused by use of R.O water as well.

Second, a zirconium coating layer is very thin as compared with a phosphate coating layer and is thus prone to rust during a process. The amount of zirconium coating layer is 50 to 200 mg/m² that amounts to about 1/10 to 1/20 relative to the phosphate coating layer with a coating layer amount of 2000 to 3000 mg/m². In a coating (chemical conversion) process for automobiles, about 20 minutes after the coating (chemical conversion) process, a subsequent process is initiated. Water originating from the zirconium coating (chemical conversion) process may be left on the metallic material such as steel that is exposed to the air about 20 minutes before undergoing the next process, thus creating rust.

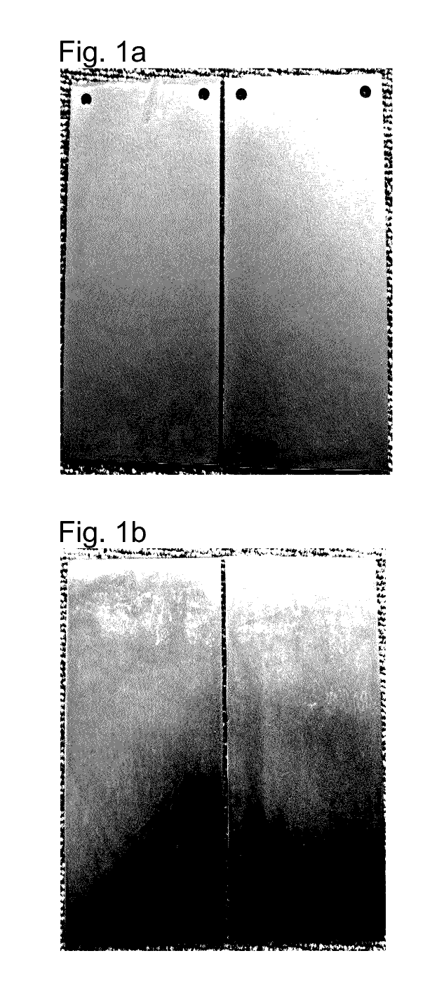

In an experiment by the inventors under the conditions closest to those in the real-life industrial site, a steel material, when left aside for 20 minutes after zirconium coated, was rusted as evident from FIG. 1(b).

FIGS. 1a and 1b are photographs showing results obtained by conducting natural drying 20 minutes after phosphate coating and zirconium coating that leave the water used for rinsing. Specifically, FIG. 1a shows the result obtained by the natural drying 20 minutes after the phosphate coating, and FIG. 1b the result obtained by the natural drying 20 minutes after the zirconium coating.

The rust created as shown in FIG. 1b may cause stains on the painted surface or adhesion failures.

Accordingly, according to the present invention, there is proposed a method for producing an eco-friendly zirconium coating agent that may allow for use of industrial water (electrical conductivity of 300 μs/cm or less).

A reason for use of deionized water or R.O water in the zirconium coating process or its prior rinsing process is as follows. If industrial water is used in the processes, the residue or calcium ions (Ca²⁺) after the industrial water is evaporated may react with the fluorine ions (F⁻) in the zirconium coating layer to produce a fluoride (e.g., calcium fluoride (CaF)) that may damage the chemical conversion coating and that, upon electrodeposit painting, may cause painting failures due to fine sludge. Further, calcium salts may be deposited in the circulating pipes installed for zirconium coating process, clogging the pipes.

Accordingly, it is recommended to adopt deionized water or R.O water with a calcium ion (Ca²⁺) content of 25 mg/l or less and without chlorine ions (Cr) and sulfate ions (SO₄⁻) for use in zirconium coating agents. Typically, industrial water contains an evaporation residue with a content up to 300 mg/l and calcium ions (Ca²⁺) of 75 mg/l or less, and is thus inappropriate for use in zirconium coating agents.

Table 2 below shows water quality standards for typical industrial water, i.e., water:

TABLE 2

| | Water standards for | | For rinsing metal | |
|---|---|---|---|---|
| Items | industrial water | | products | |
| Turbidity | 20 | (Max) | 16 | (Max) |
| pH | 6.5~8.0 | | 7.0 | |
| CaCO3(mg/l) | 75 | (Max) | 40 | (Max) |
| Total | 120 | (Max) | 50 | (Max) |
| Hardness(mg/l) | | | | |
| Evaporation | 250 | (Max) | 300 | (Max) |
| residue (mg/l) | | | | |
| Cl⁻ ion(mg/l) | 80 | (Max) | 10 | (Max) |
| Fe ion(mg/l) | 0.3 | (Max) | 0.1 | (Max) |
| Mn ion(mg/l) | 0.2 | (Max) | 0.1 | (Max) |

| | | |
|---|---|---|
| Source | Japanese industrial | p. 25, water-waste water guide |
| | water association | published by Kukjeiyeonsa |

As described above, however, use of deionized water or R.O water in zirconium coating process should be preceded by build-up of a manufacturing facility that requires management and high costs. Accordingly, an enhancement is needed.

The inventors found, in a research for allowing industrial water to be used in zirconium coating process, that such may be achieved by preventing generation of a fluoride such as calcium fluoride (CaF) and its deposit, e.g., by leaving calcium ions (Ca²⁺) in the industrial water and fluorine ions (F⁻) in the existing zirconium coating agent to be in the phase of free ions while banning them from bonding. In other words, using a material with a stronger bonding force than calcium fluoride (CaF), as dissolved in water, or a material obstructing bonding with calcium fluoride (CaF) would allow for use of tap water or industrial water.

The inventors did a test using an organic functional group (hereinafter, “O.F.G”) as a material fitting the purpose, coming up with a result that calcium ions (Ca²⁺) in the industrial water remain dissolved without bonding with fluorine ions (F⁻) in the zirconium coating agent to aiding in forming a zirconium conversion coating.

This may work in the following principle:

(1) Action Between O.F.G and Calcium

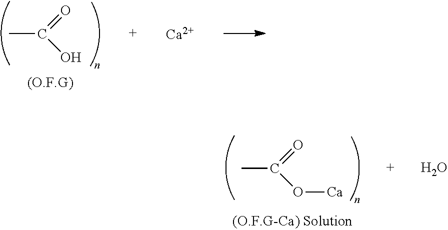

(2) Coating Reaction (Chemical Reaction Formula)

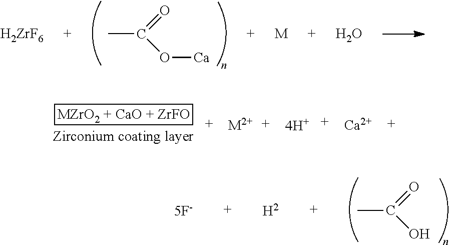

where, M is an iron, zinc (Zn) or aluminum (Al) material

According to the present invention, a method is implemented to give an anti-rust property to the eco-friendly zirconium coating agent that may prevent the material from rusting during a process.

As set forth supra, the zirconium coating layer is thin and is thus vulnerable to corrosion. Hence, when the zirconium coating agent is applied to a steel material, the material rusts for about 20 minutes from chemical conversion coating to painting.

In the automobile industry, typically three types of composite materials, such as a steel plate, a zinc-plated steel plate, and an aluminum-steel plate, are together put to use in the process, and so, they are highly likely to rust. This may cause painting failures, and thus, the anti-rust property needs to be reinforced.

A typical approach to provide an anti-rust property is to put zinc and manganese ions, alone or in combination, in the zirconium coating agent. However, such metallic ions are environmentally regulated to a limited usage.

According to the present invention, calcium ions (Ca²⁺), free from environment regulations, are employed to allow the zirconium agent an anti-rust property.

According to the present invention, an O.F.G used herein,

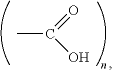

has been verified to remain a soluble solution,

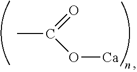

by bonding with calcium ions (Ca²⁺).

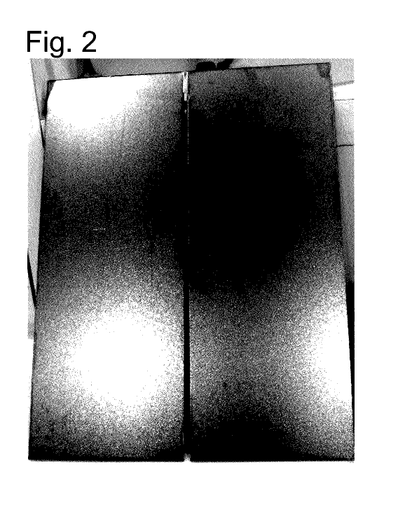

According to the present invention, a result of adding calcium ions (Ca²⁺) of 20 to 150 mg/l necessary for an anti-rust property and an O.F.G of 25 to 300 mg/l for preventing creation of a fluoride showed that the steel material, even treated by zirconium coating, remained rust-free with a high satisfaction level as shown in FIG. 2.

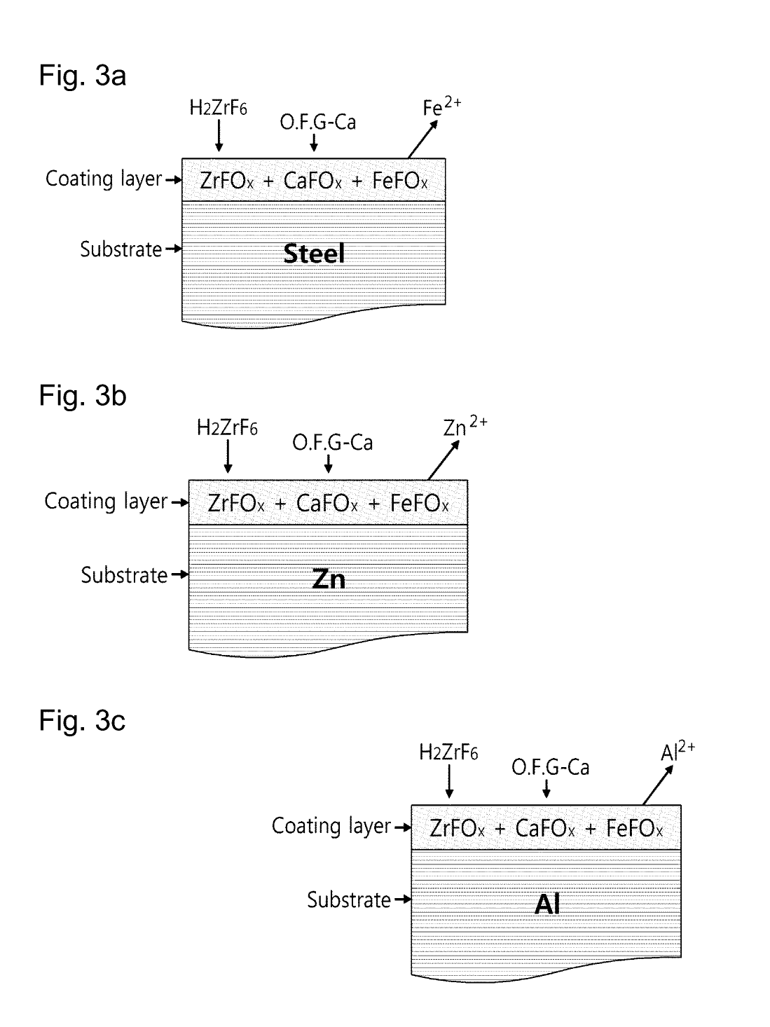

FIGS. 3a to 3c are concept views illustrating formation of a zirconium coating on steel, zinc, and aluminum materials according to embodiments of the present invention.

FIG. 3a is a concept view illustrating formation of a zirconium coating on a steel material. FIG. 3b is a concept view illustrating formation of a zirconium coating on a zinc (Zn) material. FIG. 3b is a concept view illustrating formation of a zirconium coating on an aluminum (Al) material.

The concept shown in FIGS. 3a to 3c may be represented with functional groups, as follows:

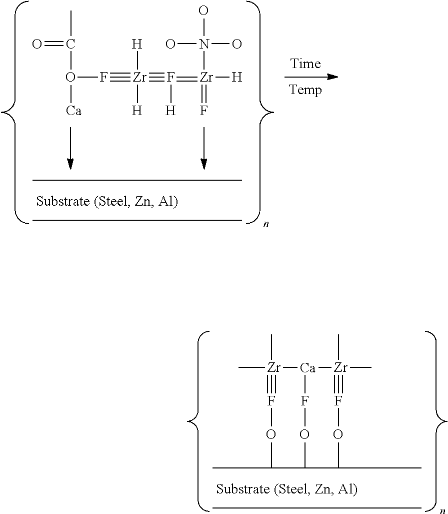

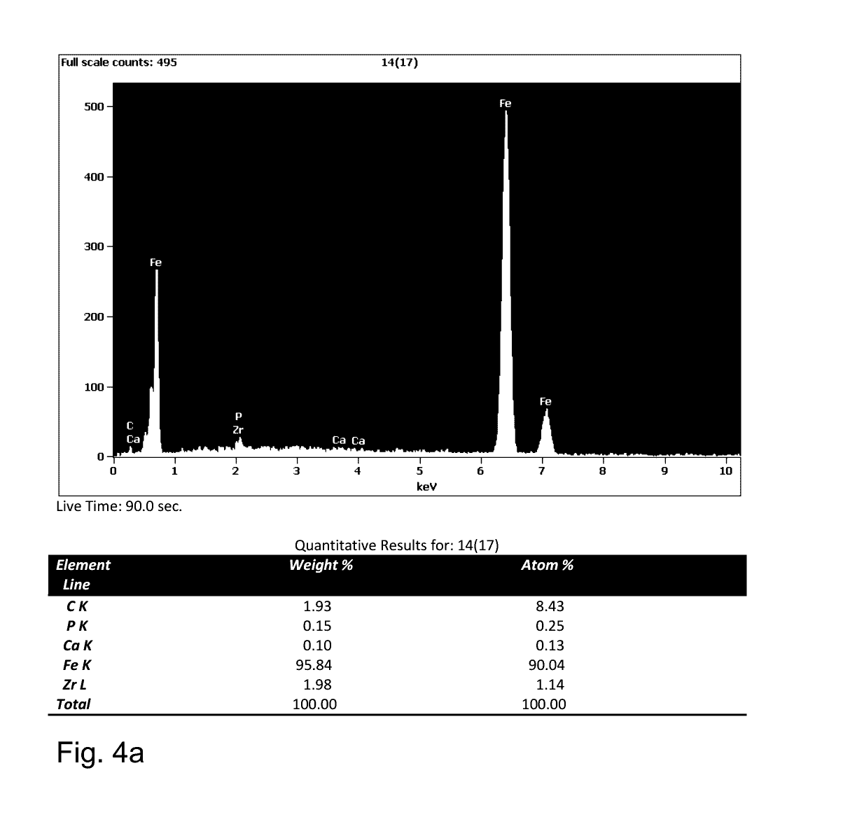

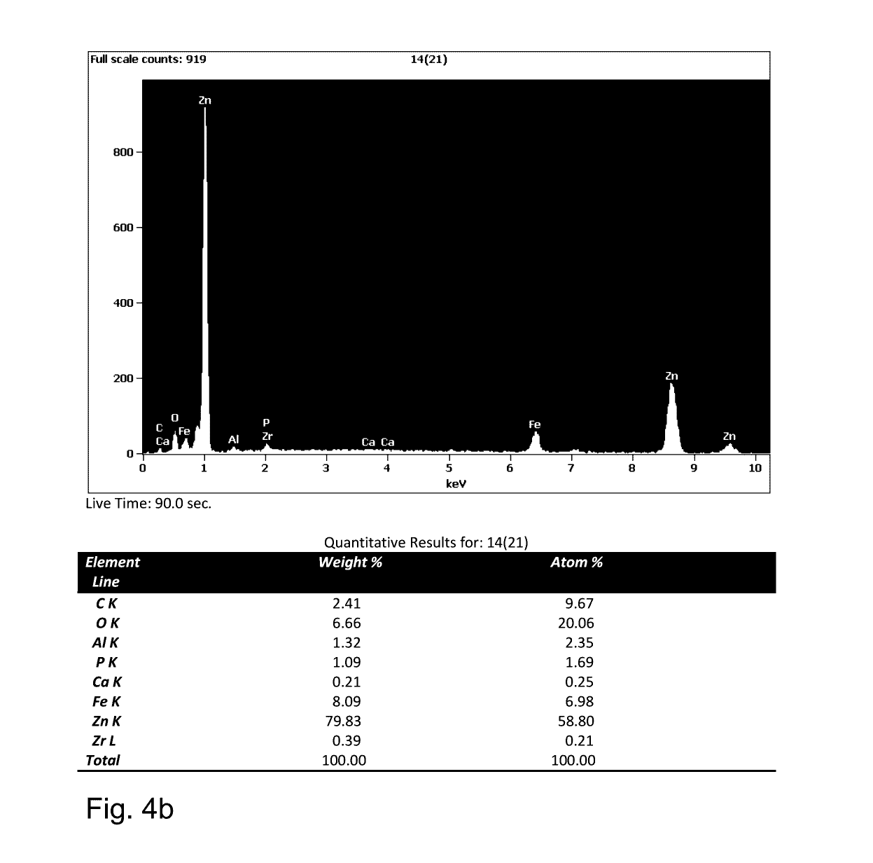

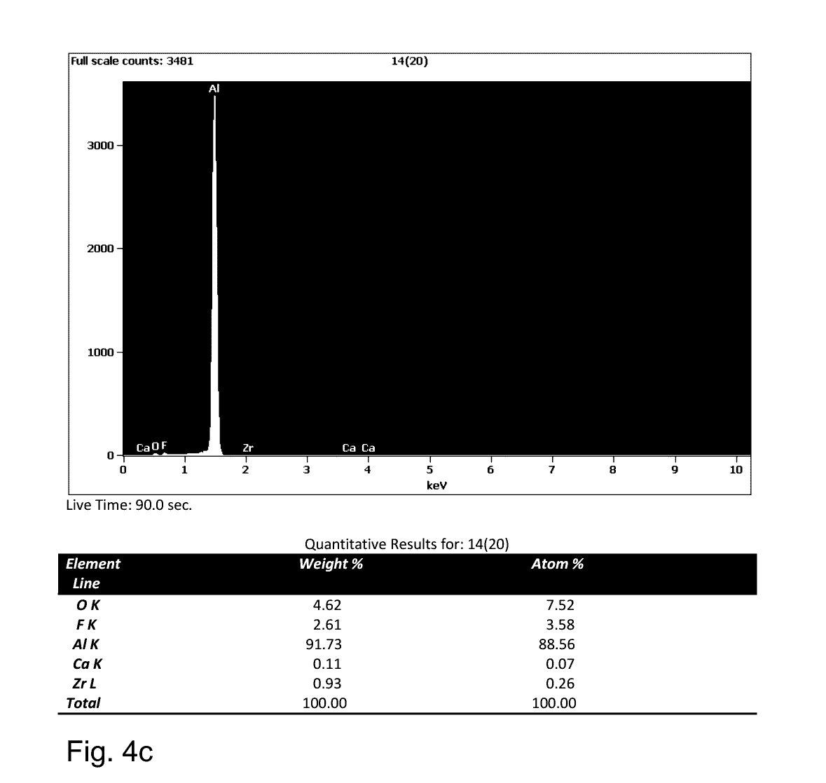

The inventors investigated the components of the zirconium coating layers formed on the surface of the steel, zinc (Zn), and aluminum (Al) specimens using energy dispersive x-ray spectroscopy (EDS) in order to figure out FIGS. 3a to 3c and resultantly acquired measurement results as shown in FIGS. 4a to 4c.

FIG. 4a illustrates a table and spectrum graph showing the result of the EDS qualitative analysis on the zirconium coating layer formed on the surface of the steel specimen. FIG. 4b illustrates a table and spectrum graph showing the result of the EDS qualitative analysis on the zirconium coating formed on the surface of the zinc (Zn) specimen. FIG. 4c illustrates a table and spectrum graph showing the result of the EDS qualitative analysis on the zirconium coating formed on the surface of the aluminum (Al) specimen.

As evident from FIGS. 4a to 4c, the zirconium coating contains calcium ions (Ca²⁺).

According to the present invention, an O.F.G is used to allow industrial water to be used in processing with a zirconium coating agent, and calcium ions are added to the zirconium coating agent to provide the zirconium coating agent an anti-rust property to prevent rusting while the zirconium coating process proceeds.

The calcium ions in the industrial water and the calcium ions separately added to provide an anti-rust property may bond with fluorine ions (F⁻) essentially contained in the zirconium coating agent, forming a deposit of calcium fluoride (CaF). According to the present invention, the O.F.G contained in the zirconium coating agent, ahead of the fluorine ions (F⁻), bonds with the calcium ions, thus preventing generation of a calcium fluoride deposit. According to the present invention, the O.F.G may be preferably an anion carboxyl group.

According to an embodiment of the present invention, the following Table 3 summarizes the ions constituting the eco-friendly zirconium coating agent and the concentration of the ions.

TABLE 3

| | Ion content | | Ion content |
|---|---|---|---|
| Ion name | (mg/l) | Ion name | (mg/l) |
| \textcircled{1}O. F. G | 20~300 | \textcircled{2}Zr⁺⁺ | 30~500 |
| \textcircled{3}Ca⁺⁺ | 20~150 | \textcircled{4}Zn⁺⁺ | 50~300 |
| \textcircled{5}F⁻ | 20~150 | \textcircled{6}Mn⁺⁺ | 30~200 |
| \textcircled{7}Ag⁺ | 0~20 | \textcircled{8}Fe⁺⁺ | 0~50 |
| \textcircled{9}NO₃⁻ | 0~50 | \textcircled{10}B⁻³ | 0~150 |

The composition of a zirconium coating agent according to the present invention as set forth above in Table 3 is described below in greater detail.

\textcircled{1} As the O.F.G, an anion carboxyl group was used with a content of 20 to 300 mg/l as measured by measurement method 1 to be described below.

\textcircled{2} As a zirconium ion (Zr²⁺)-containing compound, hexafluoro zirconic acid (H₂ZrF₆), zirconium tetrafluoride (ZrF₄), zirconium sulfate (ZrSO₄), or zirconium nitrate (Zr(NO₃)₂.nH₂O) was used and was diluted with industrial water to have a content of 30 to 500 mg/l for Zr²⁺ ions upon make-up so as to provide a function as coating agent.

\textcircled{3} According to the present invention, as a calcium ions (Ca²⁺) compound, calcium nitrate (Ca(NO₃)₂) or calcium sulfate (CaSO₄) was used and was diluted with industrial water to have a content of 20 to 150 mg/l upon make-up so as to provide a function as coating agent (chemical conversion agent).

\textcircled{4} As a zinc ion compound, zinc nitrate (Zn(NO₃)₂.nH2O) and zinc sulfate (ZnSO₄) was used and diluted with industrial water to have a content of 50 to 300 mg/l for Zn2+ ions upon make-up in order to function. This value corresponds to 1/100 of those of existing chemical conversion agent.

\textcircled{5} As a fluorine ion compound, Hydrogen Fluoride (HF) or Fluoboric Acid (HBF₄) was used (sometimes, Fluorosilic Acid may come in use) and was diluted with industrial water to have a content of 20 t 150 mg/l upon make-up, in order to function.

\textcircled{6} As a manganese ion compound, manganese nitrate (Mn(NO₃)₂) was used and diluted with industrial water to have a content of 30 to 200 mg/l for Mn2+ ions so as to function.

\textcircled{7} As a silver (Ag) compound, Silver Nitrate (AgNO₃) was used and diluted with industrial water to have a content of 0 to 20 mg/l upon make-up in order to function.

\textcircled{8} As an iron (Fe) compound, Ferric Nitrate (Fe(NO₃)₂) was used and diluted with industrial water to have a content of 0 to 50 mg/l upon make-up so as to function.

\textcircled{9} No other compound than the metallic compounds listed in (2) to (8) above were used for nitrate ions (NO₃).

\textcircled{10} Boric ions (B⁻³) are provided when the fluoroboric acid is put to use, and nothing more are added for boric ions.

Table 4 below shows pre or post processes related to a zirconium coating process using a zirconium coating agent with the composition as described above, according to the present invention.

TABLE 4

| Process name | | | | | | | | |
|---|---|---|---|---|---|---|---|---|
| | | | 4. | | | | | |
| | | | coating | | | | | 9. |
| | | | (chemical | | | 7. | | electro |
| 1. | 2. | 3. | conversion) | 5. | 6. | rinsing with | 8. | deposit |
| degreasing | rinsing | rinsing | process | rinsing | rinsing | pure water | drying | painting |

| | | | | | | | |
|---|---|---|---|---|---|---|---|
| Temperature | 45° C. | Room | Room | 20~35° C. | Room | Room | Room |
| | | temperature | temperature | | temperature | temperature | temperature |
| Time | 2 min. | 1 min. | 1 min. | 15 to 120 sec. | 1 min. | 1 min. | 1 min. |
| Water used | Industrial | Industrial | Industrial | Industrial | Industrial | Industrial | Deionized |
| | water | water | water or | water or | water | water or | water or |
| | | | tab water | tab water | | tab water | R.O water |

In the process 4 for performing coating with a liquid zirconium coating agent according to the present invention, the liquid zirconium coating agent contains calcium ions (Ca²⁺) of 20 to 150 mg/l and zirconium ions of 30 to 500 mg/l, and industrial water (electric conductivity of 100 to 300 μs/cm) or pure water may be used as the water used upon make-up in the coating process.

In the rinsing processes 3 and 6 immediately before the zirconium coating process, industrial water (electric conductivity of 100 to 300 μs/cm) or tab water may be used as water for rinsing.

This is remarkably distinct from using deionized water or R.O water with an electric conductivity of 50 μs/cm or less as water used during make-up in the existing zirconium coating process or used for rinsing before the zirconium coating process as mentioned in connection with Table 1.

Further, according to the present invention, the zirconium coating process is performed at 20 to 35° C. for 15 to 120 seconds, permitting use of relatively low energy as compared with the conventional phosphate coating process that is conducted at a temperature more or less than 45° C.

Some specific embodiments of the present invention are described below in connection with Table 5.

TABLE 5

| | | | Enibodiment | | | | | Measurement |
|---|---|---|---|---|---|---|---|---|
| NO | ION name | | 1 | 2 | 3 | 4 | 5 | method |
| 1 | O. F. G | mg/l | 25 | 102 | 158 | 216 | 304 | Refer to |
| | | | | | | | | measurement |
| | | | | | | | | method 1 |
| 2 | Zr²⁺ | mg/l | 31 | 85 | 149 | 334 | 485 | I.C.P |
| 3 | Ca²⁺ | mg/l | 20 | 62 | 96 | 115 | 150 | I.C.P |
| 4 | Zn²⁺ | mg/l | 52 | 123 | 163 | 215 | 301 | I.C.P |
| 5 | F⁻ | mg/l | 151 | 98 | 70 | 53 | 23 | Refer to |
| | | | | | | | | measurement |
| | | | | | | | | method 2 |
| 6 | Mm²⁺ | mg/l | 32 | 74 | 104 | 156 | 202 | I.C.P |
| 7 | Ag⁺ | mg/l | 0 | 5 | 10 | 16 | 27 | I.C.P |
| 8 | Fe²⁺ | mg/l | 0 | 6 | 25 | 12 | 51 | I.C.P |
| 9 | NO₃⁻ | mg/l | 3 | 11 | 25 | 5 | 58 | Ion meter, |
| | | | | | | | | Refer to |
| | | | | | | | | measurement |
| | | | | | | | | method 2 |
| 10 | B⁻³ | mg/l | 0 | 17 | 0 | 82 | 150 | Refer to |
| | | | | | | | | measurement |
| | | | | | | | | method 3 |
| 11 | PO₄⁻³ | mg/l | none | none | none | none | none | I.C.P |

| 12 | Electric conductivity | | 1.8 | 2.3 | 2.8 | 3.9 | 7.2 | Electric |
|---|---|---|---|---|---|---|---|---|
| | (ms/cm) | | | | | | | conductivity |
| | | | | | | | | meter |
| 13 | Total acidity | | 35 | 22 | 14 | 12 | 10 | Refer to |
| | (0.01M NaOH) | | | | | | | measurement |
| | | | | | | | | method 4 |
| 14 | PH | | 2.8 | 3.5 | 4.3 | 4.8 | 5.6 | Using Ph meter |
| 15 | Adhesion test | | good | good | good | good | good | Refer to |
| | | | | | | | | measurement |
| | | | | | | | | method 5 |
| 16 | Impact-resistance test | | good | good | good | good | good | Refer to |
| | | | | | | | | measurement |
| | | | | | | | | method 6 |
| 17 | 5% or less warm salt | | good | good | good | good | good | Refer to |
| | water soaking test | | | | | | | measurement |
| | (50% 240 HR) | | | | | | | method 7 |
| 18 | 5% or less warm salt | | 2 m/m or | 1 m/m or | 1 m/m or | 1 m/m or | 1 m/m or | Refer to |
| | water spraying test | | less on | less on | less on | less on | less on | measurement |
| | 1000 HR | | side | side | side | side | side | method 8 |
| 19 | Folding-endurance test | | good | good | good | good | good | Refer to |
| | | | | | | | | measurement |
| | | | | | | | | method 9 |
| 20 | Zr content | R | 35 | 62 | 95 | 130 | 165 | Refer to |
| | in coating | | | | | | | measurement |
| | (mg/m²) | | | | | | | method 10 |
| | | A | 22 | 38 | 54 | 61 | 80 | Refer to |
| | | | | | | | | measurement |
| | | | | | | | | method 10 |
| | | l | 43 | 65 | 82 | 109 | 146 | Refer to |
| | | | | | | | | measurement |
| | | | | | | | | method 10 |

According to the present invention, a feature is to use tap water or industrial water with an electric conductivity of 100 to 300 μs/cm. The measured values in Table 5 are ones obtained using inductively coupled plasma (I.C.P).

The measurement methods introduced in Table 5 above are now described in further detail.

Measurement Method 1: O.F.G Measurement Method

1) An inter-process specimen solution or make-up solution of 5 ml is taken in a 300 ml round bottle flask using a mass hole pipette and is added with about 100 ml of distilled water.

2) 1:1 H₂SO₄ solution of 10 ml is added,

3) 0.1N—KMnO₄ standard solution of 10 ml is dripped using a mass hole pipette,

4) A Liebig condenser is assembled at the opening of the rounded bottle flask, and the solution is boiled for about 30 minutes, with the vapor being dripped into the rounded bottle flask. The rounded bottle flask is dissembled from the condenser. Turning transparent after boiling, the solution is added with 0.1N—KMnO₄ of 10 ml and is then boiled again for 30 minutes (check whether it turns red or dark red).

5) A 0.1N—Na₂C₂O₄ standard solution of 10 ml is taken using a mass hole pipette. Then the color turns from red (0.1N—KMnO₄) or dark red into colorless. (upon adding about 0.1N—KMnO₄, it should have been added by its added amount.)

6) At the end point, which is the moment when the color lasts 20 seconds or more with the 0.1N—KMnO₄ standard solution while the temperature remains at 80±10° C., titration is conducted, and “A” in the following content calculation equation is replaced with the consumed amount (ml).

7) Blank test: 5 ml of industrial water or tap water as used between processes is taken and added with about 100 ml of distilled water, and steps 2) to 6) are performed. “B” in the following content calculation equation is replaced with the consumed amount (ml) of 0.1N—KMnO₄.

8) Calculation of O.F.G content (X)

$$X = A - ( B + C ) \times f \times \frac{1000}{5} \times 0.2 [ mg \text{/} l ]$$

where, f: factor of 0.1N—KMnO4

5: ml of specimen

C: ion amount of iron (Fe) (iron ions supposed to increase between processes are measured (this may be omitted for a new solution), (a 5 ml specimen between processes is taken, and added with 1:1 H₂SO₄ of 10 ml and distilled water of 100 ml, and a 0.1N—KMnO4 solution is titrated at a room temperature, and “C” is replaced with the consumed amount (ml) of 0.1N—KMnO₄ at the end point, which is the moment when the pink color lasts 30 seconds or more).

Measurement Method 2: Measurement of Content of F⁻ Ions and NO₃ Ions

A well calibrated ion meter is used to measure the content (mg/l) of F⁻ ions and NO₃ ions.)

Measurement Method 3: Measurement of Boric Ions (B²⁻)

A boric ion testing kit is used. The model used herein is PACKTEST WAK-B (Sechang INS (02-6292-1000).

Measurement Method 4: Total Acidity Measurement

An inter-process specimen of 10 ml is taken in its accurate amount into a 100 ml conical flask and is added with three or five drips of phenolphthalein (ph.pht) indicator and is then titrated with 0.01M-NaOH. The amount (ml) consumed at the end point, which is the moment when the color turns from colorless into pink is referred to as total acidity (TA).

Measurement Method 5: Adhesivity Test

When a zirconium-coated specimen, when cut in the shape of a grid with squares each being 1 mm long in width, nowhere should the coating layer peel off by 50% or more in the forward direction.

Measurement Method 6: Impact-Resistance Test

A DuPont impact tester is used. A 1 kg head is dropped from a height of 50 cm onto the coating layer, and it is checked whether the coating is damaged. In this case, the coating should not be damaged.

Measurement Method 7: 5% or Less Warm Salt Water Soaking Test

A specimen with a “+”-shaped cut is soaked for 240 hours in a thermostatic bath containing 5% salt water (NaCl) while remaining at 50° C. Then, the specimen is cleaned thoroughly, and a piece of cellophane tape is rubbed onto the cut part. Upon detaching the tape, the coating loss on side should not exceed 3 mm.

Measurement Method 8: 5% Salt Water Spraying Test

A salt water sprayer is used to spray 5% salt water (NaCl) for 1000 hours at 35° C. The coating loss on side of the cross cut should not exceed 3 mm.

Measurement Method 9: Folding-Endurance Test

A folding-endurance tester is used. When snapped at 360° on a round bar Φ10 m/m, the coating specimen should not exhibit peeling-off.

Measurement Method 10: Measurement of Content of Zr in Coating

An XRF (X-ray fluorencence) analysis apparatus is used to measure the content three times, and an average thereof is obtained in mg/m².

The following Table 6 is a summary of coating performance test results obtained by conducting eco-friendly zirconium coating according to an embodiment of the present invention.

As shown in Table 6, the inventors could verify that the zirconium coating according to the present invention met the performances required for each test.

According to embodiments of the present invention, the following effects may be obtained.

First, according to the present invention, an eco-friendly metal surface treating agent is provided with minimized environment contaminants. Conventional phosphate surface treating agents, as described above in the DISCUSSION OF RELATED ART section, contain a vast amount of environmental contaminants. However, the eco-friendly zirconium coating agent according to the present invention may reduce environmental pollution to about 1/100 relative of the conventional coating agents.

Table 7 is a result of comparison between a conventional phosphate surface treating agent and a zirconium coating agent according to an embodiment of the present invention:

| | | Conventional | Present | |
|---|---|---|---|---|
| | | phosphate | invention | |
| items | permitted | coating agent | (2~3% | |
| materials | emissions | (5~6% make-up) | make-up) | remarks |
| Total nitrogen | 60 | 500~2000 | 3~50 | |
| (mg/l) | | | | |
| Total phosphor | 8 | 5000~30000 | None | |
| (mg/l) | | | | |
| Zn(mg/l) | 5 | 1500~3000 | 50~300 | |
| Mn(mg/l) | 10 | 500~5000 | 30~200 | |
| Cu(mg/l) | 2 | 5~10 | 1~5 | |
| Ni(mg/l) | | 500~5000 | None | Law under |
| | | | | revision |
| Ca(mg/l) | None | None | 20~150 | |

The materials and permitted emissions are based on Korean Environment Preservation Act, and the make-up concentration is the concentration at which chemical conversion coating is conducted.

Second, the present invention allows for use of industrial water, thus eliminating the need of changes in the conventional processes required upon use of a phosphate coating agent or the need of installing an additional facility, e.g., an ion exchanger. As described above in the SUMMARY section, some European countries recommend use of deionized water or R.O water in the zirconium coating process. However, the zirconium coating agent according to the present invention allows for use of industrial water and thus does not require an additional apparatus for producing deionized water or pure water while saving operation efforts and costs.

Third, the zirconium coating agent according to the present invention contains calcium ions (Ca²⁺) that may enhance anti-rust properties and painting adhesivity after painting. This is considered to result from calcium ions' unique coating compactability and affinity with the zirconium coating. However, it is preferable that the content of calcium ions is in a range from 20 to 150 mg/l because 200 mg/l or more of calcium ions may damage the coating.

Fourth, the present invention may significantly reduce industrial waste (e.g., sludge). According to the prior art, when contacted by a phosphate coating agent, a metallic material (e.g., steel, Zn, or Al), may be etched, leaving precipitates in the processing tank. The precipitates are filtered out in a filtering process and handled as industrial waste. According to the present invention, a zirconium coating agent may reduce sludge created in the coating process to about 1/10 relative of the conventional art.

Fifth, the present invention may save energy by performing coating at low temperature. A typical phosphate coating process should be conducted at 45° C. for two minutes. However, according to the present invention, the coating process is fulfilled at 20 to 35° C. for 15 to 120 seconds, leading to saved energy along with increased convenience.

Finally, the present invention allows for simultaneous coating on a number of metallic materials, including steel, zinc (Zn), and aluminum (Al) thanks to fluorine ions (F⁻) contained in the zirconium coating.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

### INDUSTRIAL APPLICABILITY

The present invention may be used as a pre-treatment agent for painting vehicles or metals and may be used in a metal surface treatment for enhanced painting quality.

What is claimed is:

1. A phosphor-free, eco-friendly zirconium coating agent allowing use of industrial water, the zirconium coating agent composed by adding, to a conventional zirconium coating agent essentially containing fluorine ions (F⁻), a material having a bonding force larger than calcium fluoride (CaF) and preventing a material dissolved in water from bonding with calcium fluoride (CaF) to thus allow industrial water or tab water with a calcium ion (Ca²⁺) content up to 75 mg/l and an electric conductivity of 100 to 300 μs/cm to be used in a zirconium coating process or a rinsing process prior to the zirconium coating process.

2. The phosphor-free, eco-friendly zirconium coating agent of claim 1, wherein the material is an organic functional group (O.F.G):

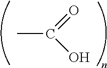

3. The phosphor-free, eco-friendly zirconium coating agent of claim 2, wherein the O.F.G is an anion carboxyl group.

4. The phosphor-free, eco-friendly zirconium coating agent of claim 1, further comprising calcium ions (Ca²⁺) to allow an anti-rust property and an anti-corrosive and painting adhesive property after painting.

5. The phosphor-free, eco-friendly zirconium coating agent of claim 2, wherein a content X of the O.F.G is obtained using the following equation:
$$X = A - ( B + C ) \times f \times \frac{1000}{5} \times 0.2 [ mg \text{/} l ]$$
where, f: factor of 0.1N—KMnO4
5: ml of specimen
C: ion amount of iron (Fe)

6. A phosphor-free, eco-friendly zirconium coating agent allowing for use of industrial water, the zirconium coating agent composed to contain, at least, calcium ions (Ca²⁺) of 20 to 150 mg/l, zirconium ions of 30 to 500 mg/l, and an organic functional group (O.F.G) of 25 to 300 mg/l to allow for use in a zirconium coating process or a rinsing process prior to the zirconium coating process and to provide an anti-rust property and an anti-corrosive property and adhesivity after painting.

7. The phosphor-free, eco-friendly zirconium coating agent of claim 6, wherein the O.F.G is an anion carboxyl group.

8. A phosphor-free, eco-friendly zirconium coating agent allowing for use of industrial water, -), the zirconium coating agent containing an organic functional group (O.F.G) having a bonding force larger than calcium fluoride (CaF) and preventing a material dissolved in water from bonding with calcium fluoride (CaF) to thus allow industrial water or tab water to be used in a zirconium coating process or a rinsing process prior to the zirconium coating process, wherein the O.F.G has the following structural formula: 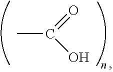
and wherein a zirconium coating layer is formed by a coating action following the following chemical reaction equation using the zirconium coating agent:

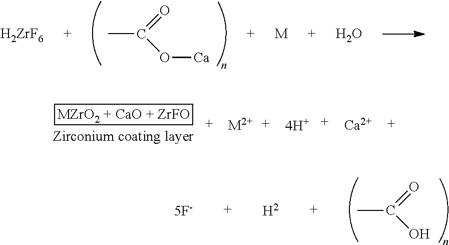

9. A phosphor-free, eco-friendly zirconium coating agent allowing for use of industrial water, the zirconium coating agent containing a functional group by which a zirconium coating layer is formed by performing a coating process on a steel, zinc (Zn), or aluminum (Al) material with the zirconium coating agent, wherein the O.F.G is configured to be represented in the following chemical formula:

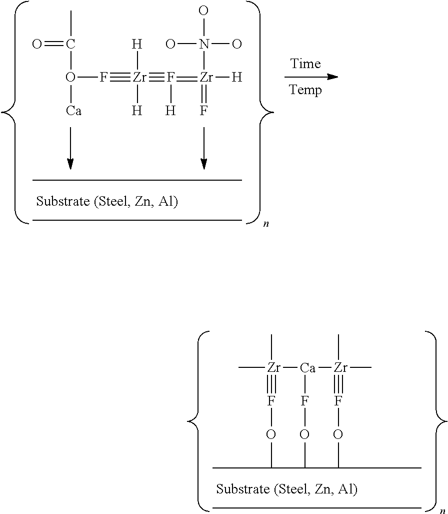

10. A method of using a phosphor-free, eco-friendly zirconium coating agent allowing for use of industrial water, the zirconium coating agent being a liquid agent containing calcium ions of 20 to 150 mg/l, zirconium ions of 30 to 500 mg/l, and an organic functional group (O.F.G) of 25 to 300 mg/l and used in a zirconium coating process, wherein industrial water or tab water (electric conductivity of 100 to 300 μs/cm), not deionized water or R.O water with an electric conductivity of 50 μs/cm or less is adopted in a make-up process of the zirconium coating process or a rinsing process prior to the zirconium coating process.

11. The method of claim 10, wherein coating in the zirconium coating process is performed for 15 seconds to 120 seconds at 20 to 35° C.
